(19) United States
(12) Patent Application Publication
(10) Pub. No.: US 2024/0035973 A1
(43) Pub. Date: Feb. 1, 2024

(54) METHODS AND COMPOSITIONS OF STABLE THALLIUM FLUX ASSAYS FOR DETECTING MODULATORS OF ION CHANNELS

(71) Applicant: ION Biosciences, San Marcos, TX (US)

(72) Inventors: Derek Hernandez, Austin, TX (US); Charles David Weaver, Franklin, TN (US)

(21) Appl. No.: 18/344,534

(22) Filed: Jun. 29, 2023

Related U.S. Application Data
(60) Provisional application No. 63/357,764, filed on Jul. 1, 2022.

(51) Int. Cl. G01N 21/64; C09K 11/62

(52) U.S. Cl. CPC G01N 21/6428; C09K 11/62; G01N 2021/6439

(57) ABSTRACT

Disclosed are thallium-sensitive assay methods and compositions for identifying effectors of monovalent ion channels, transporters, or channel-linked receptors. Further described are methods that extend the detection window of an assay to ensure assay compatibility with basic fluorescence plate readers, fluorescence microscopes, high content screening instrumentation, and flow cytometers. The ability to conduct ion mobilization screens on additional instrumentation also enables significantly more complex data acquisition, analysis, and interpretation.

### PRIORITY CLAIM

This application claims priority to U.S. Provisional Application Ser. No. 63/357,764, filed Jul. 1, 2022, entitled “METHODS AND COMPOSITIONS OF STABLE THALLIUM FLUX ASSAYS FOR DETECTING MODULATORS OF ION CHANNELS”, which is incorporated herein by reference.

### BACKGROUND

### 1. Field of the Invention

The invention generally relates to methods, compositions, and kits for measuring ion channel activity in a cell.

### 2. Background

Fluorescence-based thallium flux assays have been used to measure monovalent cation channel and transporter activity, and modulators of those targets, for decades. At present, thallium flux assays are comprised of solutions and fluorescent thallium indicators with methods designed to measure thallium influx rates. Kinetics are typically rapid, lasting from 1 to 600 seconds, as cells in all groups approach the same tonic equilibrium after the addition of thallium. Short detection windows, however, limit a user's ability to use a broader array of analytical instrumentation, such as standard fluorescence plate readers, fluorescence microscopes, and flow cytometers in ion channel and transporter assays.

### SUMMARY OF THE INVENTION

Described herein are methods, products, and kits that can be used to identify and/or measure the activity of an effector of an ion channel or transporter in a sample comprising cells having one or more cell types. The method comprises: loading a thallium-sensitive fluorescent indicator and thallium inside of the cells in the sample; contacting the cells with the effector; and measuring the change in fluorescence of the indicator in cells or in the medium surrounding the cells.

Generally, an effector is a compound that interacts with an ion channel receptor or transporter directly or indirectly to affect the activity of the ion channel or transporter. In an embodiment, the effector is an ion channel inhibitor or an ion channel activator. In other embodiments, the effector interacts with, and alters the activity of, an ion channel transporter. Exemplary effectors include GPCRs, protein kinases, or a protein phosphatases.

Cells used in the test described herein, generally, exhibit a basal influx of thallium. Exemplary cells include primary cells or induced pluripotent stem cells (iPSCs). Specific cell lines that can be used include Chinese hamster ovary (CHO) cells, Human embryonic kidney (HEK) cells, or HeLa cells.

In an embodiment, the thallium-sensitive fluorescent indicator is loaded into the cells prior to adding thallium to the cells. Subsequently, the addition of thallium to the cells increases the fluorescence of the thallium-sensitive fluorescent indicator. In one embodiment, the thallium-sensitive fluorescent indicator is loaded into the cells prior to adding thallium to the cells. In another embodiment, the thallium-sensitive indicator is loaded into the cells in the presence of thallium ions. The thallium-sensitive indicator may be an organic thallium chelating agent. Examples of organic thallium chelating agents include, but are not limited to, Thallos, Thallos Gold, FluxOR, BTC, or TL-520.

In an embodiment, the method further comprises adding a control composition to the cells that are loaded with a thallium-sensitive fluorescent indicator and thallium, wherein the control composition does not include an effector compound. In this embodiment, measuring the change in fluorescence of the cells after addition of the effector compound comprises comparing the change in fluorescence of the cells when an effector compound is added to the change in fluorescence of the cells when the control composition is added. In another embodiment, measuring the change in fluorescence of the cells comprises acquiring the fluorescence of the cells before adding the effector compound and comparing the fluorescence of the cells after adding the effector compound to the fluorescence of the cells before adding the effector compound.

The change in fluorescence can be determined by measuring the change in fluorescence of the indicator in cells or in the medium surrounding the cell using a fluorescence microscope. The fluorescence microscope can be a high content screening microscope.

In an embodiment, the cells are loaded into a fluorescence plate reader before loading the cells with a thallium-sensitive fluorescent indicator and thallium. Measuring the change in fluorescence of the cells can be performed with a fluorescence plate reader.

In another embodiment, the change in fluorescence of the cells is measured with a flow cytometer. The flow cytometer can be used to acquire multiple sequential fluorescent measurements. For example, the flow cytometer can be used to acquire simultaneous fluorescent measurements of multiple effectors. Alternatively, the flow cytometer can be used to acquire simultaneous fluorescent measurements of multiple cells.

In an embodiment, the method further comprises obtaining an image of the cells prior to the addition of an effector compound and obtaining an image of the cells after the addition of an effector compound.

Two or more cell types can be present in the sample. In an embodiment, one cell type is discriminated from another cell type using a fluorescent tag, fluorescently encoded protein, spatial information, cell morphology, or a combination of these features.

The methods described herein allow the use of fluorescence efflux to measure the activity of effectors easily and accurately on ion channels and ion mobilization using common laboratory fluorescence readers.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 is a workflow schematic of one possible embodiment, where thallium is added after dye loading and before compound addition;

FIG. 2 is a workflow schematic of one possible embodiment, where the dye loading solution contains thallium;

FIG. 3 is a workflow schematic of one possible embodiment, where the dye loading solution contains thallium and fluorescence is only acquired once;

FIG. 4: (Left) Representative kinetic plots of assay conducted on CHO GIRK cells with the activator VU0466551 (referred to as VU551 throughout the remainder of this document).

(Right) Representative time resolved fluorescence profiles of treated wells for 40 minutes after the addition of VU551;

FIG. 5: (Left) Overlay of normalized dose response curves acquired using new method. Data was acquired using different analytical methods or instruments, and all three result in similar profiles and reported EC50 values. (Right) Dose response curve acquired using traditional thallium flux assay methods, demonstrating a comparable EC50 to the new method;

FIG. 6: Data acquired on a plate reader using the workflow in FIG. 1 on CHO GIRK cells treated with either a vehicle (DMSO) or compound (VU551) in a checkerboard pattern on a 96 well plate. The resulting F/Fo values are reported in table (top) and plot form (bottom), with a calculated Z score of 0.56;

FIG. 7: (Top row) depicts a cell targeting demo using image based analysis in co-cultures; (Bottom row) depicts analysis of subpopulations results in independent time resolved fluorescence profiles;

FIG. 8 depicts a collection of kinetic plots and dose response curves for voltage gated sodium channels (NaV 1.3) using traditional thallium flux (left) and the proposed method (center). Corresponding dose response curves are shown at right, revealing similar IC50 values for both methods;

FIG. 9 (Left) depicts a kinetic plot of proposed method extended to >50 minutes after the addition of compound; (Middle) depicts images of cells in control or compound group, with the corresponding image analysis plots; (Right) depicts images acquired 60 minutes after the addition of veratridine;

FIG. 10 depicts a collection of kinetic plots and dose response curves for a voltage gated potassium channel (hERG) target using traditional thallium flux (left) and the proposed method (center);

FIG. 11 depicts (Left) kinetic plots of hERG assays using different concentrations of extracellular thallium; (Right) images of cells in control or compound group;

FIG. 12 depicts images of cells in a control (top left) or a compound group (top right) using HEK hERG cells and terfenadine (terf); (Bottom left) Image analysis to quantify normalized cell fluorescence relative to frame 1 (Fₒ), acquired before the addition of a high potassium solution. (Bottom right) Data acquired using a plate reader of the same wells showing similar fluorescence profiles over time to image based analysis;

FIG. 13 depicts (Left) Kinetic plot of fluorescence using method proposed in FIG. 1. (Middle) Data acquired using a plate reader 20 or 60 minutes after the addition of ouabain plotted as a dose response curve resulting in an IC50 of ˜7 micromolar using the analytical method proposed in FIG. 3. (Right) Representative images of cells acquired after the addition of ouabain in a control and high concentration group. (Top Right) Corresponding dose response curve using microscopy and image based analysis result in a similar IC50 value to other modes of analysis;

FIG. 14 depicts images of cells loaded with a sodium indicator. The image in the right panel is acquired with a Texas Red filter cube;

FIG. 15 depicts images and graphs associated with changes in sodium indicator fluorescence during addition of ouabain;

FIG. 16 depicts images and graphs associated with changes in a potassium indicator fluorescence in the presence of VU551;

FIG. 17 depicts a well plate-based layout showing F/Fo for control (green) and treated (yellow) groups;

FIG. 18 depicts an overlay of histograms of CHO GIRK1/2 cell fluorescence in treated and control cells;

FIG. 19 depicts the kinetic profile of CHO GIRK1/2 median cell fluorescence;

FIG. 20 depicts relative fluorescence of CHO GIRK1/2 cells treated with a GIRK activator using Brilliant Thallium Gold as the indicator; and

FIG. 21 depicts fluorescence images of vehicle (lower left) and VU 551 treated CHO G12 cells (upper right).

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

The present disclosure describes a novel approach to conduct thallium flux assays to identify effectors of monovalent ion channels, transporters, and channel-linked receptors using instruments not previously accessible to thallium flux assays. These instruments include a fluorescence microscope, a basic plate reader, a high content screening instrument, and a flow cytometer.

Methods described herein include an approach to thallium flux assays that results in a detectable and sustained signal for use in drug discovery and screening applications. Prior to the addition of one or more effector(s) (which can be known or unknown), cells are incubated in one or more solutions containing a thallium-sensitive indicator and a thallium salt, which results in a detectable signal (e.g., fluorescence) inside the cells. After the addition of the effector(s), thallium may or may not be extruded from cells and a change in fluorescence or lack thereof, respectively, can be recorded.

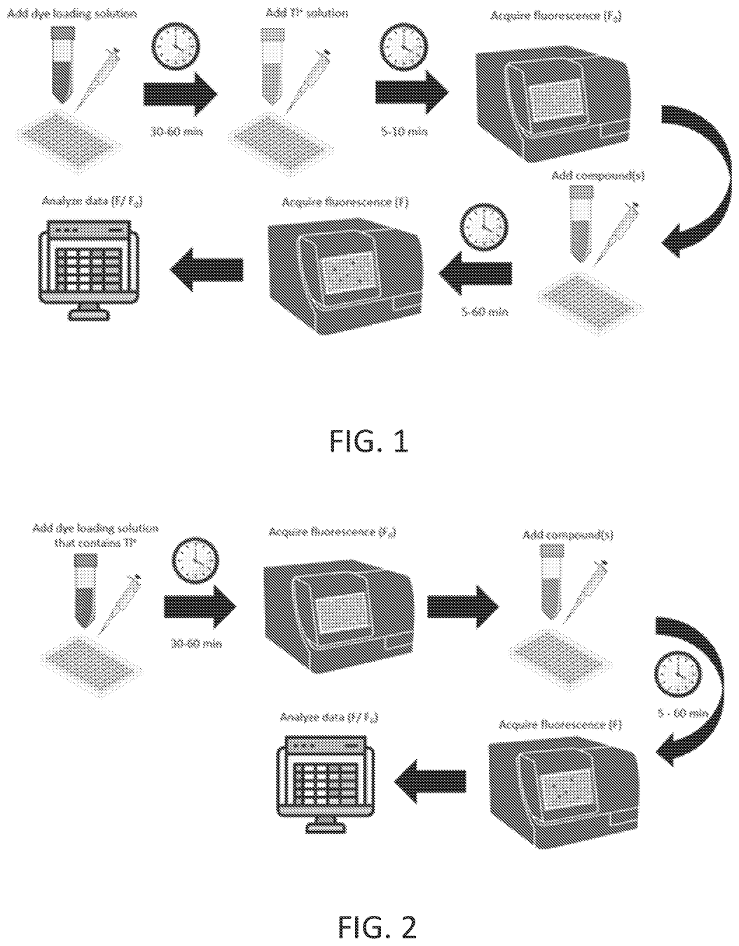

In one embodiment, schematically depicted in FIG. 1, a dye loading solution that includes a thallium-sensitive fluorescent indicator (“dye”) is added to the cells. The dye loading solution can include other reagents that enhance loading of the thallium-sensitive fluorescent indicator into the cells, including, but not limited to poloxamers, probenecid, and/or masking reagent(s) which block extracellular fluorescence. Cells are treated with the dye loading solution for a period of time prior to the addition of a thallium containing solution. After a period of time, the initial fluorescence data (Fₒ) is acquired using an instrument of the end user's choice. Then known effector(s), compounds that may be effectors, or control solutions are added. After an additional delay, where the time of delay depends on a multitude of factors including cell type, target, extracellular thallium concentration, and other factors, another fluorescence reading is acquired using the same instrument (F).

In contrast to thallium influx tests, which typically rely on hard to access fluorescent imaging plate readers, thallium efflux testing can be performed using common fluorescence imaging equipment found in most laboratories. For example, the thallium efflux testing described in the present disclosure can be performed using a fluorescence microscope or a flow cytometer. In some embodiments, the fluorescent microscope is a high content screening device.

When using a fluorescence microscope, the cells can be placed on a fluorescence plate reader before loading the cells with a thallium-sensitive fluorescent indicator and thallium. In another embodiment, a flow cytometer can be used to detect the change in fluorescence. A flow cytometer can be used to acquire fluorescent measurements sequentially.

Additionally, thallium influx tests suffer from flux of thallium through alternative ion channels and transporters that are not the intended target of the desired measurements. The influx of thallium through other sources compresses the dynamic range and detection window of an assay. In contrast to influx experiments, the signal amplitude and dynamic range of an efflux assay is sustained for an extended period of time after the addition of an effector.

Data can be analyzed to determine if any lead compound(s) were identified as hits for a specific target. In one embodiment, the ratio, F/Fₒ, can be used to determine if a compound has an effect on ion mobilization within the cell. Ion mobilization can be controlled by a number of biological targets, referred to herein as “ion mobilizers.” Examples of ion mobilizers include, but are not limited to, ion channels and ion transporters. As used herein the terms “effector” and “effector compounds” refer to a compound that alters the normal function of a cellular ion mobilizer, or a compound that acts as an agonist, an antagonist, an allosteric modulator, inhibitor, positive modulator, negative modulator, or a potentiator of an ion mobilizer in a cell. Effectors can be ion channel blockers, ion channel activators, or ion channel transporters. Exemplary classes of effectors include, but are not limited to, G-protein coupled receptors (GPCRs, e.g., Gi/o GPCR), protein kinases, and protein phosphatases. Other effectors include compounds that interact with an ion-channel receptor or transporter. Since the test relies on thallium efflux, it is expected that in the presence of an effector compound, thallium concentrations inside the cell will change. For example, the cellular thallium concentration becomes reduced (in the presence of an ion channel activator) or the cellular thallium concentration will remain the same (in the presence of an ion channel blocker). Control compositions are compositions that do not include an effector compound. In some embodiments, a control composition has the same composition as the composition used to deliver the effector compound but does not include any compounds that act as effectors of the cells ion channel.

A variety of cells having a basal influx of thallium can be tested. Exemplary cells that can be tested include, but are not limited to, Chinese hamster ovary (CHO) cells, Human embryonic kidney (HEK) cells, and HeLa cells. Culture systems can contain two or more cell types (co-cultures, organoids, lab-on-a-chip), and a cell or group of cells can be selectively “targeted” to monitor cell-specific effects of a compound of interest on an expressed target. One cell type is discriminated from another cell type using a fluorescent tag, fluorescently encoded protein, or some other discriminating feature, including spatial information or cell morphology, to acquire cell-specific or population specific data.

The extent to which an effector compound activates or inhibits a target of interest can be correlated to additional features of cells, including gene expression, protein expression, or other relevant biological metrics. Cells expressing a target of interest can be identified within a diverse population of cells.

FIG. 4 shows representative kinetic plots of an assay conducted on CHO GIRK cells with the ion-channel activator VU551. In the left-side graph, the shaded red box indicates that low background efflux is achieved. In the right-side graph, representative time resolved fluorescence profiles of treated wells are shown for 40 minutes after the addition of VU551. Signal amplitude is sustained for the duration of the experiment, resulting in a long detection window (shaded box). Reported concentrations of VU551 are in micromolar. The F/F₀ values become progressively lower for increasing amounts of VU551.

Because of the longer detection windows, monitoring the efflux of thallium ions offers a number of advantages over traditional methods which rely on thallium ion influx. One advantage lies in the long detection time available during efflux. Under the detection conditions set forth herein, thallium ions exit the cell through the ion channel or via a transporter. In a typical experiment, the fluorescence of the cells can be monitored from the time the effector compound (or control compound) is introduced to the cell for up to about 60 minutes. This is in contrast to thallium influx tests which are typically only capable of measurement for up to about 600 seconds (10 minutes) after introduction of the effector.

In another embodiment, schematically depicted in FIG. 2, a dye-loading solution that includes a thallium-sensitive fluorescent indicator and a thallium salt is added to the cells. The dye loading solution can include other reagents that enhance loading of the thallium-sensitive fluorescent indicator/thallium salt into the cells, including, but not limited to poloxamers, probenecid, and/or masking reagent(s) which block extracellular fluorescence. After a period of time, the initial fluorescence data (Fₒ) is acquired using an instrument of the end user's choice. Then known effector(s), compounds that may be effectors, or control solutions are added. After an additional delay, where the time of delay depends on a multitude of factors including cell type, target, extracellular thallium concentration, and other factors, another fluorescence reading is acquired using the same instrument (F).

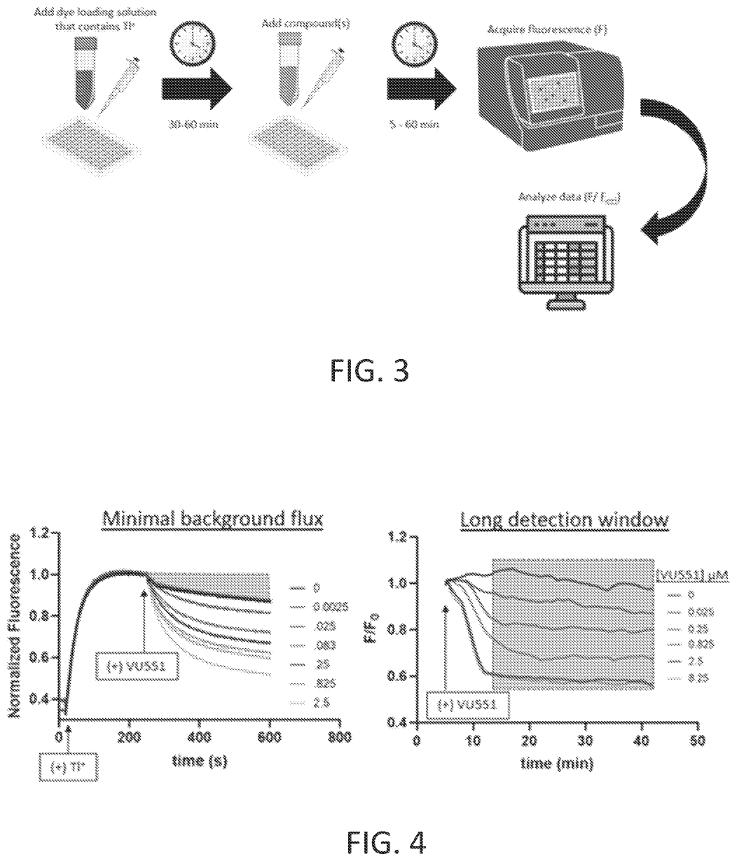

In another embodiment, schematically depicted in FIG. 3, a dye loading solution that includes a thallium-sensitive fluorescent indicator and a thallium salt is added to the cells. The dye loading solution can include other reagents that enhance loading of the thallium-sensitive fluorescent indicator/thallium salt into the cells, including, but not limited to poloxamers, probenecid, and/or masking reagent(s) which block extracellular fluorescence. After a period of time test compositions, having known effector(s) and/or compounds that may be effectors, and control compositions are added. After an additional delay, where the time of delay depends on a multitude of factors including cell type, target, extracellular thallium concentration, and other factors, a fluorescence reading is acquired using an instrument of the user's choice. Data can be analyzed to determine if any lead compound(s) were identified as hits for a specific target by comparing fluorescence of cells treated with the test compositions to cells treated with the control compositions.

In some embodiments, the method includes obtaining an image of the cells prior to the addition of an effector compound and obtaining an image of the cells after the addition of an effector compound.

In some embodiments, two or more cell types are present in the sample being tested with effector compounds. In some embodiments, one cell type can be discriminated from another cell type using a fluorescent tag, fluorescently encoded protein, spatial information, cell morphology, or a combination of these features.

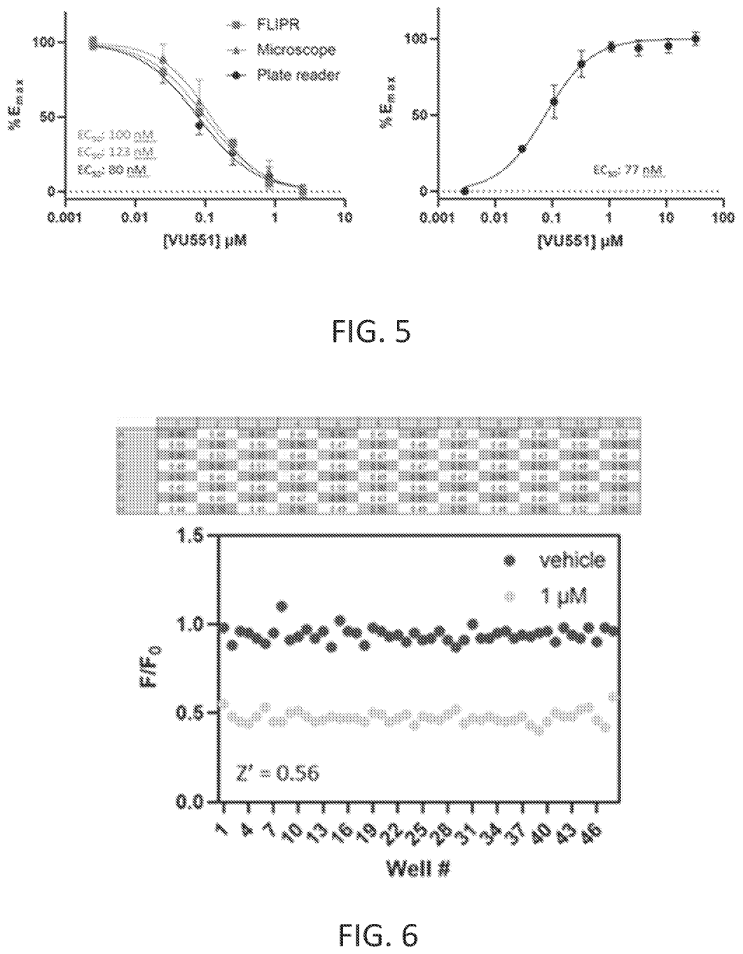

In a comparative test of the efflux method disclosed herein, EC50 values were determined using VU551 as the effector. Three different instruments were used to monitor the change in fluorescence: 1- kinetic imaging plate reader (Hamamatsu FDSS), 2 - fluorescent microscope; 3- fluorescent plate reader. FIG. 5 depicts an overlay of normalized dose response curves acquired using the efflux method described herein. Regardless of the method of data collection, all three instruments provided similar profiles and reported similar EC₅₀ values. In the right graph of FIG. 5, a dose response curve acquired using traditional thallium flux assay methods is shown. An EC₅₀ of 77 nm, for VU551, was determined using the traditional thallium flux method. The use of a plate reader to determine the EC₅₀ in the efflux method produced the closest result to the traditional method.

In another test of the method, data was acquired on a plate reader using the test method depicted in FIG. 1. CHO GIRK cells were treated with either a vehicle (DMSO, control composition) or compound (VU551) in a checkerboard pattern on a 96-well plate. The resulting F/Fₒ values are shown in FIG. 6. The results were obtained in array form from (top) and plot form (bottom), with a calculated Z score of 0.56.

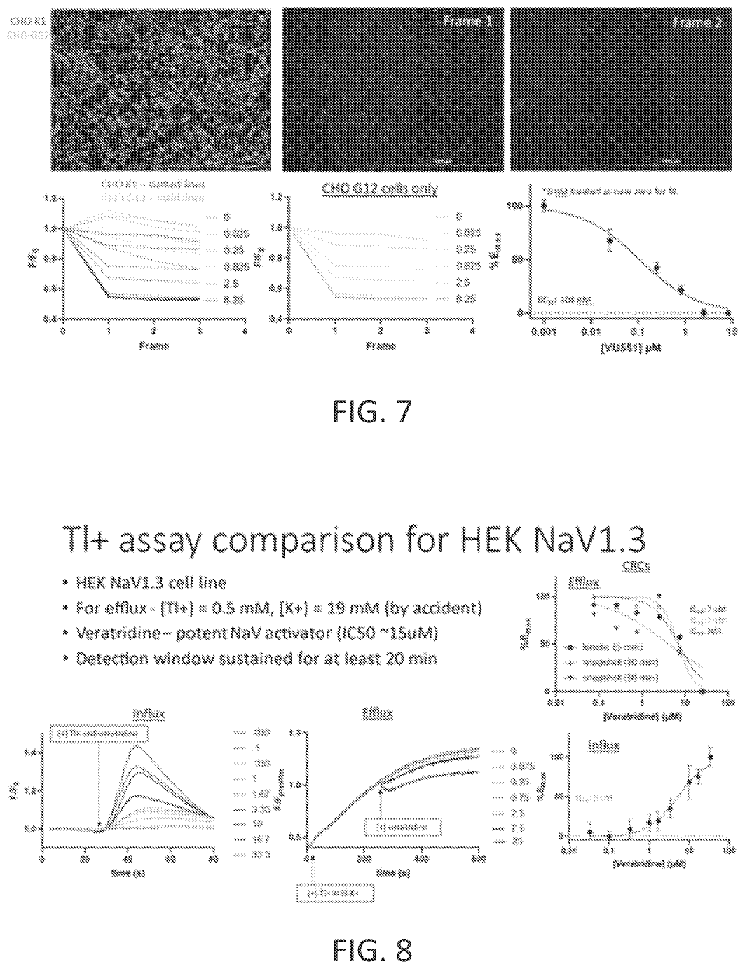

Imaging based detection methods can also be used in the efflux method described herein. A cell targeting experiment was performed using image-based analysis in co-cultures. CHO K1 cells were stained prior to plating with cytotracker red, and images acquired using Texas Red filters were used to discriminate between stained and unstained cells. A representative subpopulation mask is shown in FIG. 7 in the top left block identifying each cell type. Images were acquired before (Frame 1) and 10 minutes after (Frame 2) the addition of VU551. An obvious change in fluorescence is observed in the CHO G12 (CHO cells overexpressing GIRK1 and GIRK2 subunits) population in Frame 2. In the bottom row of FIG. 7, the results of an analysis of subpopulations results in independent time resolved fluorescence profiles. When analyzing only the CHO G12 response, a dose-dependent response can be generated that results in a comparable EC50 to data reported in FIG. 5.

FIG. 8 shows a collection of kinetic plots and dose response curves for voltage gated sodium channels (NaV 1.3) using traditional thallium flux (Influx, left panel) and the efflux method (Efflux, center panel). Corresponding dose response curves are in the right panel of FIG. 8, revealing similar IC50 values for both methods.

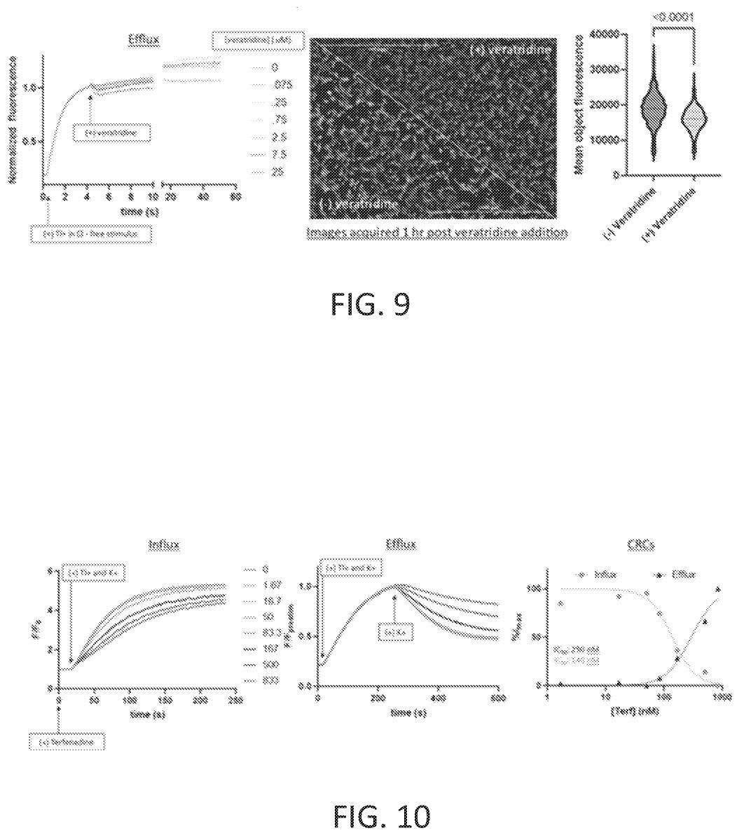

FIG. 9 depicts a kinetic plot of an efflux experiment extended to >50 minutes after the addition of the effector (veratridine). Discrimination between the control and highest concentration of effector remains possible for the duration of data acquisition. The middle panel shows images of cells in a control group ((−) veratridine) or effector group (+)-veratridine, with the corresponding image analysis plots (right panel). Images were acquired 60 minutes after the addition of veratridine.

FIG. 10 depicts a collection of kinetic plots and dose response curves for a voltage-gated potassium channel (hERG) target using traditional thallium influx (left panel) and the efflux method (center panel). Corresponding dose response curves are shown in the right panel, revealing similar IC50 values for both methods.

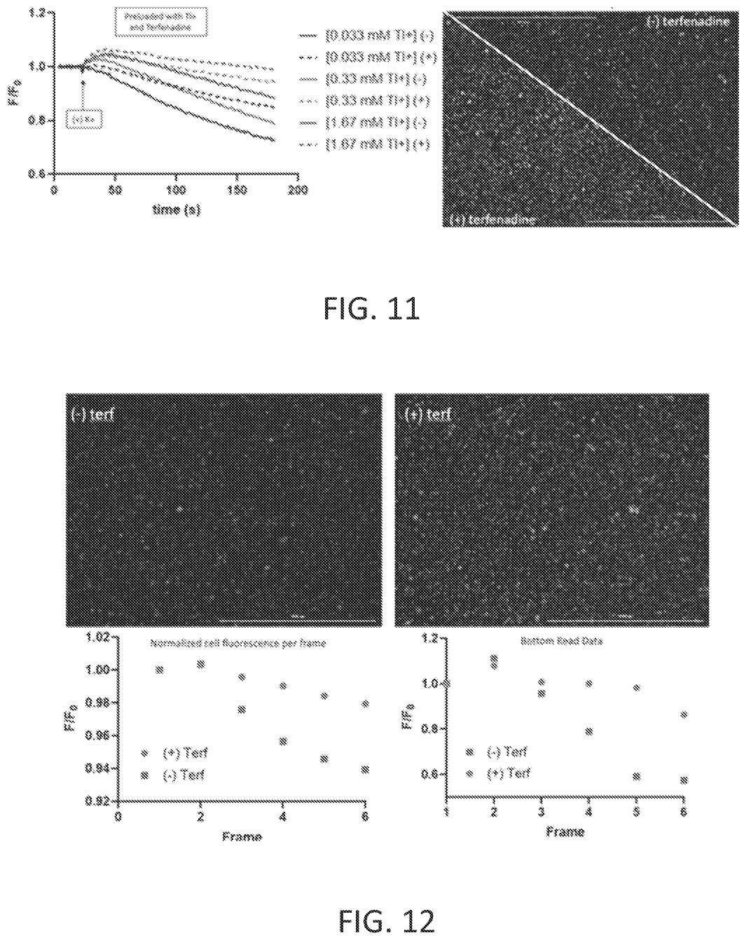

In FIG. 11, the left panel shows kinetic plots of hERG efflux assays using different concentrations of extracellular thallium. This experiment demonstrates that a thallium concentration will likely need to be optimized on an assay-to-assay basis. In the right panel, images of cells in control group (−) terfenadine and the effector group (+terfenadine) are shown. Images were acquired 2-10 minutes after the addition of a high potassium solution. In this case, terfenadine blocks thallium efflux, resulting in a higher mean cell fluorescence in the treated group when compared to the control.

In FIG. 12, images of cells in the control group (top left panel) or effector group (top right panel) using HEK hERG cells and terfenadine as the effector (terf) are shown. Images were acquired before and 2-10 minutes after the addition of a high potassium solution. Image analysis to quantify normalized cell fluorescence relative to frame 1 (Fₒ), acquired before the addition of a high-potassium solution. Each frame was acquired 2-3 minutes apart. In the bottom right panel, data acquired using a plate reader of the same wells shows similar fluorescence profiles over time to image based analysis.

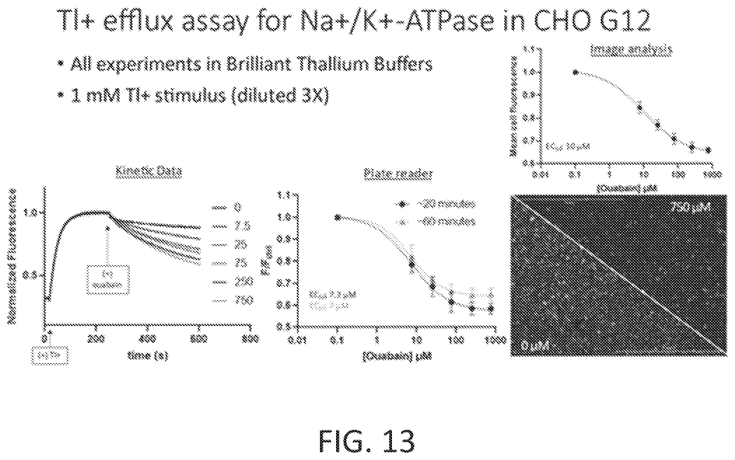

In FIG. 13, a kinetic plot of fluorescence using the efflux method depicted in FIG. 1 is shown in the left panel. In the center panel, data acquired using a plate reader 20 or 60 minutes after the addition of ouabain is plotted as a dose response curve resulting in an IC50 of ˜7 micromolar using the analytical method proposed in FIG. 3. In the right panel, representative images of cells acquired after the addition of ouabain in a control and high concentration group are shown. In the top right panel, corresponding dose response curves using microscopy and image-based analysis result in a similar IC50 value to other modes of analysis.

The assays described herein can be used with sodium and potassium indicators. An exemplary sodium sensitive fluorescent indicator is ION Natrium Green-2 (ING-2, Ion Biosciences). Exemplary potassium sensitive fluorescent indicators include ION Potassium Green indicators (e.g., IPG-1, IPG-2, IPG-4, and PBFI, Ion Biosciences). In some embodiments, sodium or potassium-sensitive indicators are loaded into cells. Sodium or potassium salts, as appropriate, can be added to the cells to activate the indicator. In some embodiments, the addition of sodium salts or potassium salts is not needed as the solution used to load the indicator into the cell already contains sodium or potassium.

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### EXAMPLE 1—DYE LOADING SOLUTION

Table 1 below represents the primary composition of the dye loading solution that was applied to cells in this assay, prior to thallium addition (See FIG. 1 workflow diagram). The dye loading solution was applied for 20-90 minutes to allow the thallium indicator to load into cells prior to proceeding with the assay. In some embodiments, this solution contained thallium sulfate and the assay buffer used was composed of chloride-containing or chloride-free salts. Additionally, multiple thallium indicators were evaluated and proved effective. Probenecid is an optional component of the dye loading solution.

TABLE 1
Dye Loading Solution

| Label | Name | Amount | |
|---|---|---|---|
| Reagent A | Brilliant Thallium Indicator Solution | 20 | μL |
| Reagent B | 100X Pluronic F-127 Solution | 100 | μL |
| Reagent C | 10X Assay Buffer | 1 | mL |
| Reagent D | Probenecid Solution | 200 | μL |
| Reagent E | TRS | 200 | μL |
| | Water | 8.6 | mL |
| | Total | 10 | mL |

### EXAMPLE 2—THALLIUM STIMULUS SOLUTION

Table 2 below represents the primary composition of the Tl⁺ solution when added separately (See FIG. 1 workflow diagram). In some embodiments, the stimulus buffer used was composed of chloride-containing salts. Typical incubations with this solution were 5 minutes.

TABLE 2
Thallium Stimulus Solution

| Label | Name | Amount | |
|---|---|---|---|
| Reagent G | 10X Chloride-Free Stimulus Buffer | 1 | mL |
| Reagent J | 50 mM Thallium Sulfate Solution | 0.1 | mL |
| | Water | 8.9 | mL |
| | Total | 10 | mL |

### EXAMPLE 3—COMPOUND SOLUTION

TABLE 3
Compound Solution

| | | |
|---|---|---|
| Label | Name | Amount |

| | | |
|---|---|---|
| 1X Assay Buffer | 0.990 | mL |
| 400X Compound Solution | 10 | μL |
| Total | 1 | mL |

### EXAMPLE 4—CHO KLS AND CHO G12 CELLS

CHO K1s and CHO G12 cells were passaged from separate flasks in parallel. CHO K1s were stained in suspension with cytotracker red, a cytosolic dye that is well retained, following recommended protocols. Prior to mixing the two cell populations together for seeding a 96-well plate, the cytotracker red loading solution was aspirated from the CHO K1 cells and replaced with serum-containing medium. Cells were incubated overnight in the well plate. The following day, a thallium snapshot assay was conducted using the methods described in this application. Cells were imaged on a Cytation 5—imaging plate reader—5 minutes after the addition of Tl+ (Frame 0) then imaged again 10 minutes after the addition of VU551 (Frame 1). (See FIG. 7). Image acquisition was repeated at 10 minute intervals for a total of 3 frames. Images were acquired using GFP filters to visualize the fluorescence of the thallium indicator and Texas red filters to discriminate the cytotracker red stained CHO K1 cells. To identify the two cell populations, a manual threshold fluorescence value was selected using the Texas Red image. To generate the time-resolved fluorescence plots at the bottom, the mean cell fluorescence of the GFP image was calculated for each cell population. A corresponding concentration response curve (shown in FIG. 7) was generated using data from frame 3 in the time-resolved fluorescence plots.

### EXAMPLE 5—PROTOCOL FOR GIRK ACTIVATOR SCREENING

### Materials

CHO G12 cells—(Ion Biosciences)
Complete advanced medium (Gibco)
   +5% FBS (Corning)
   +1% glutamax (Gibco)
Brilliant Thallium Assay Kit (Ion Biosciences)
VU551 (10 mM stock in DMSO)
96 well plate (VWR, TC-treated, flat bottom)

### Methods

Day 1—Prepare plate for assay
   1 Passage CHO G12 cells using standard protocols.
   2. Seed cells in 96 well plate(s) at 30 k cells/well in 100 uL of media. Place cells in incubator overnight.
Day 2—Prepare reagents and run assay
   1. Remove all needed solutions from storage and allow to warm to room temperature.
   2. Prepare Brilliant Tl+ dye loading solution by combining the following reagents in a 50 mL conical tube.
      8.5 mL of DI H2O
      1 mL of 10X Tl+ assay buffer
      200 uL of TRS solution
      200 uL of Probenecid
      100 uL of 100X Pluronic F127
   3. Dissolve Thallos AM (25 ug/vial) in 20 uL of DMSO. Vortex, then centrifuge to dissolve. Transfer 20 uL to dye loading solution. Vortex dye loading solution to mix.
   4. Remove serum-containing medium from cell-containing wells and add back 100 uL of dye loading solution to each well. Place plate in incubator for 30 min.
   5. Prepare compound plate.
      Dilute VU551 stock to desired concentration(s) in DMSO (100× working solution concentration).
      Add 5 uL of each VU551 solution to 495 uL of 1× Brilliant Thallium Assay buffer to create 4× working solutions. Also make a vehicle control (DMSO without VU551).
      Dispense 120 uL per well of each working solution in a compound plate (96 well) using your desired layout.
   6. Prepare Thallium Stimulus solution (0.5 mM Tl₂SO₄) by combining the following reagents in a 50 mL conical tube.
      8.9 mL of DI H2O
      1 mL of Cl-free stimulus buffer
      100 uL of T125O4 stock (50 mM)
   7. After the completion of 30 min dye load, remove plate from incubator. Add 50 uL of Thallium Stimulus solution to each well.
   8. Incubate plate for 5 min (or until [Tl+] equilibrium has been reached).—See sample FIG. 4 of kinetic plots showing a typical change in fluorescence after each addition.
   9. Place plate in instrument of choice for compound addition (Flexstation, plate reader, microscope).
   10. Acquire baseline fluorescence or image data.
   11. Transfer 50 uL of 4× VU551 solution(s) from compound plate to cell-containing plate.
   12. Incubate plate for 5-10 min (or more if desired).
   13. Reacquire baseline fluorescence or image data.

The workflow for this example is depicted in FIG. 1.
Flexstation 3 instrument settings:
   1. Ex/Em: 490/520 nm, Cutoff Filter—515 nm, Flashes per read=3, Gain=Medium, Read interval=1.3 s
Cytation 5 instrument settings:
   1. Fluorescence bottom read: Ex/Em—490(9)/525(9), Gain—110, Read Mode—Sweep
   2. Imaging: Channel 1 (brightfield used for autofocus), Channel 2: GFP=469(35)/525(39) nm, LED intensity=10, exposure time=7 ms, Camera gain=24.

### EXAMPLE 6—SODIUM INDICATOR

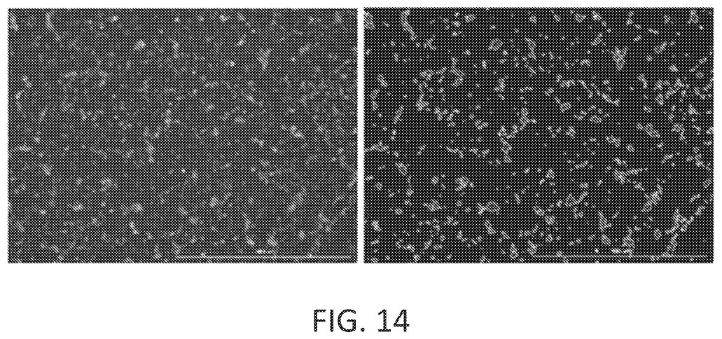

CHO K1 and HEK 293 cells were plated in coculture and loaded with a sodium indicator. HEK293 cells were stained with celltracker red prior to plating in order to discriminate between the two cell types on the same plate. Images of the cells are shown in FIG. 14. The left panel shows the cells after staining and loading with the sodium indicator. An image of the same field of view was acquired using a Texas Red filter cube (FIG. 14, right panel). HEK293 cells were selected if an object had an RFU>5000. The objects shown were classified as HEK293 cells for this analysis.

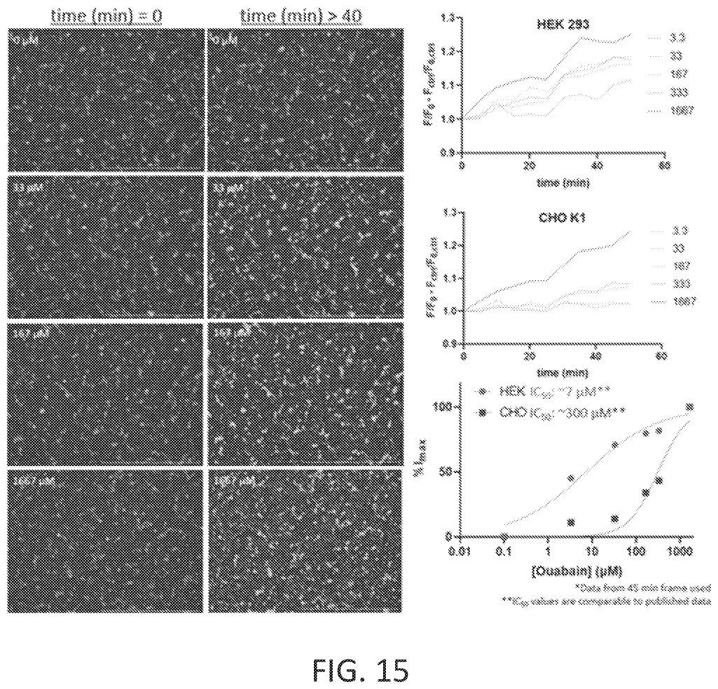

FIG. 15, left panel depicts initial images of the coculture system described above acquired immediately after the addition of ouabain at the concentration reported on the upper left of each image. The middle panel shows images of the same field of view acquired 40 minutes or more after the addition of ouabain. Changes in sodium indicator fluorescence in one or more cell types is observed, indicating an increase in intracellular sodium. In FIG. 15, top right panel, cell specific, time-resolved fluorescence plots of HEK 293 or CHO-K1 cells after the addition of ouabain at various concentrations. Masking analysis described above were used to discriminate between cell populations. Automated image analysis was used to calculate the mean fluorescence intensity of a defined cell population. In the bottom right panel, the resulting dose response curve of each cell type is shown. Ouabain is known to be more potent with human (Human embryonic kidney) Na+/K+-ATPase versus rodent (Chinese hamster ovary) Na+/K+-ATPase, as shown.

### EXAMPLE 7—POTASSIUM INDICATOR

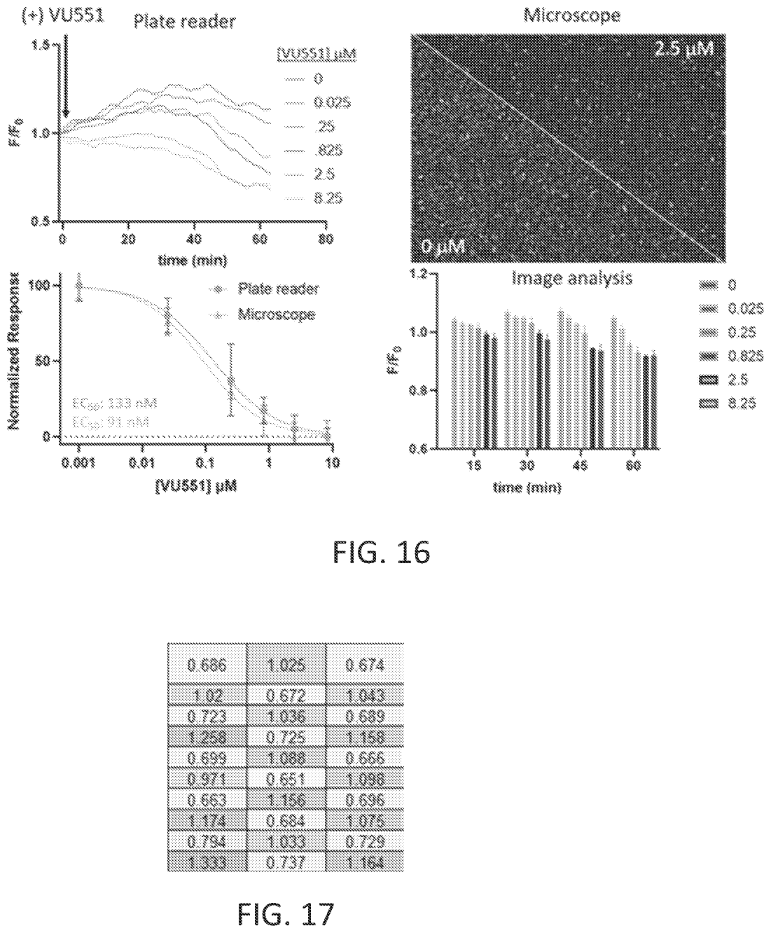

FIG. 16, top left panel, shows a time-resolved fluorescence plot of potassium indicator fluorescence in CHO-K1 cells overexpressing GIRK channels after the addition of VU551, a potent activator of the channel. The top right panel shows fluorescence images of a control and treated group acquired >30 minutes after the addition of VU551. The bottom right panel shows an automated image analysis of mean cell fluorescence yields plot showing the change in fluorescence over time associated with each group. The bottom left panel shows dose response curves generated using plate reader or microscopy-based data acquisition methods show comparable curves and calculated EC50s in line with literature reported values ˜75 nM).

FIG. 17 depicts a well plate-based layout showing F/Fo for control (green) and treated (yellow) groups. Each data point represents a single well in the experiment. Data (F) was acquired on a standard plate reader 45 minutes after the addition of 5 micromolar ML297 (an alternative GIRK activator) or a vehicle (DMSO) to CHO-K1 cells overexpressing GIRK channels. Discrimination between positive and negative controls is possible.

### EXAMPLE 8—CHO GIRK1/2 CELL FLUORESCENCE

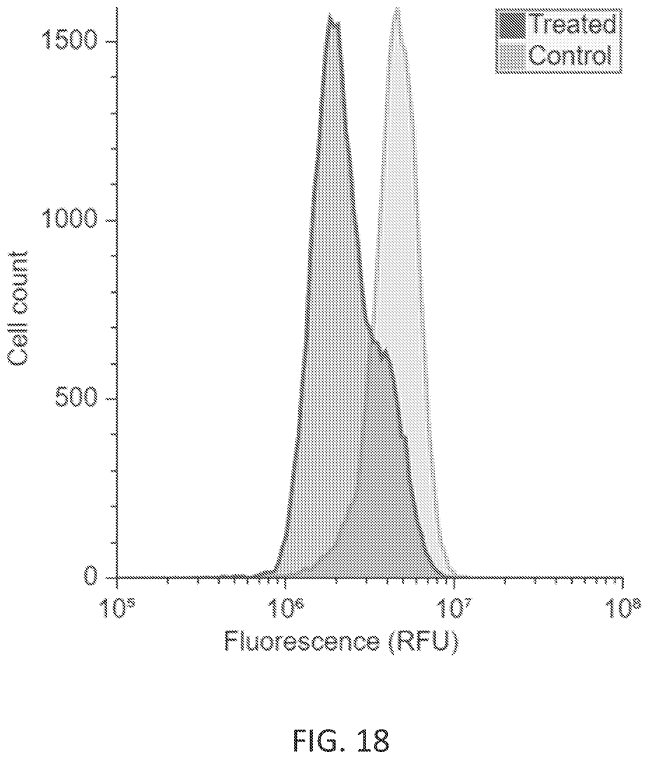

CHO GIRK cells were treated with HEPES-Buffered Hanks Balanced Salt Solution (HHBSS, Control) or GIRK activator, VU0466551 (VU551). Data was acquired 50 minutes after addition of 1 μM VU551 using a BD Accuri C6 Flow Cytometer. Mean cell fluorescence of the treated group is 2.5M RFUs versus 4.5M RFUs for the control, indicating that VU551 is a GIRK channel agonist. FIG. 18 depicts an overlay of histograms of CHO GIRK1/2 cell fluorescence in treated and control cells.

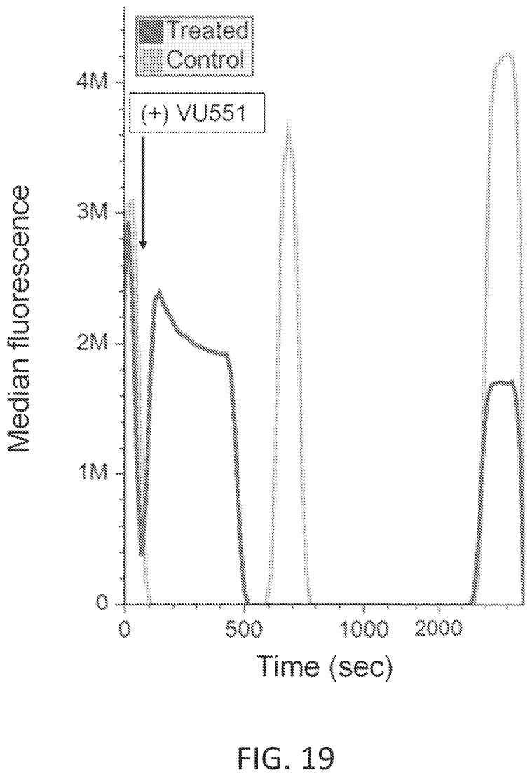

FIG. 19 depicts the kinetic profile of CHO GIRK1/2 median cell fluorescence. Sample data was acquired before and at different time points after the addition of 3 μM GIRK activator, VU0466551 (VU551) or HHBSS (control). A slow increase in fluorescence is observed in the untreated group. A rapid loss in fluorescence is observed in the treated group, indicating the GIRK channel was activated.

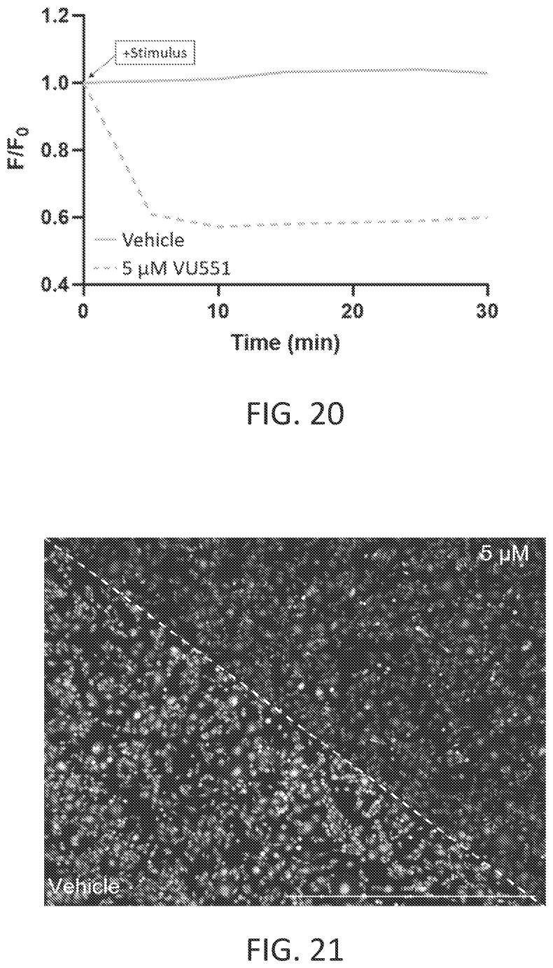

FIG. 20 depicts relative fluorescence of CHO GIRK1/2 cells treated with a GIRK activator using Brilliant Thallium Gold as the indicator. In FIG. 20, changes in signal are shown for 30 minutes as demonstrated using a standard fluorescence plate reader (Cytation 5). Reads were acquired at 5 min intervals. In FIG. 21, representative fluorescence images of vehicle (lower left) and VU 551 treated CHO G12 cells (upper right) are shown. Images were acquired 30 min after VU 551 addition using propidium iodide filters and a 4× objective Gold lookup table was applied after acquisition.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A method of identifying and/or measuring the activity of an effector of an ion mobilizer in a sample comprising cells having one or more cell types, the method comprising:
loading a thallium-sensitive fluorescent indicator and thallium inside of the cells in the sample;
contacting the cells with the effector; and
measuring the change in fluorescence of the cells or in the medium surrounding the cells.

2. The method of claim 1, wherein the effector is an ion channel blocker or an ion channel activator.

3. The method of claim 1, wherein the effector interacts with an ion transporter.

4. The method of claim 1, wherein the effector is a compound that interacts with an ion channel or transporter directly or indirectly to affect the activity of the ion channel or transporter.

5. The method of claim 1, wherein the effector is a GPCR, a protein kinase, or a protein phosphatase.

6. The method of claim 1, wherein the cells exhibit a basal influx of thallium.

7. The method of claim 6, wherein the cells are primary cells or induced pluripotent stem cells (iPSCs).

8. The method of claim 6, wherein the cells are Chinese hamster ovary (CHO) cells, Human embryonic kidney (HEK) cells, or HeLa cells.

9. The method of claim 1, wherein the thallium-sensitive fluorescent indicator is loaded into the cells prior to adding thallium to the cells, wherein the addition of thallium to the cells activates the thallium-sensitive fluorescent indicator.

10. The method of claim 1, wherein the thallium-sensitive indicator is loaded into the cells in the presence of thallium ions.

11. The method of claim 1, wherein the thallium-sensitive indicator is an organic thallium chelating agent.

12. The method of claim 11, wherein the organic thallium chelating agent is Thallos, Thallos Gold, FluxOR, FluxOR red, BTC, or TL-520.

13. The method of claim 1, further comprising adding a control composition to the cells that are loaded with a thallium-sensitive fluorescent indicator and thallium, wherein the control composition does not include an effector compound.

14. The method of claim 11, wherein measuring the change in fluorescence of the cells after addition of the effector compound comprises comparing the change in fluorescence of the cells when an effector compound is added to the change in fluorescence of the cells when the control composition is added.

15. The method of claim 1, wherein measuring the change in fluorescence of the cells comprises acquiring the fluorescence of the cells before adding the effector compound and comparing the fluorescence of the cells after adding the effector compound to the fluorescence of the cells before adding the effector compound.

16. The method of claim 1, wherein measuring the change in fluorescence of the cells or in the medium surrounding the cell is performed with a fluorescence microscope.

17. The method of claim 14, wherein the fluorescence microscope is a high content screening instrument.

18. The method of claim 1, wherein the cells are loaded onto a fluorescence plate reader.

19. The method of claim 18, wherein measuring the change in fluorescence of the cells is performed with a fluorescence plate reader.

20. The method of claim 1, wherein measuring the change in fluorescence of the cells is performed with a flow cytometer.

21. The method of claim 20, wherein the flow cytometer can be used to acquire sequential fluorescent measurements.

22. The method of claim 20, wherein the flow cytometer can be used to acquire simultaneous fluorescent measurements of multiple effectors.

23. The method of claim 20, wherein the flow cytometer can be used to acquire simultaneous fluorescent measurements of multiple cells.

24. The method of claim 1, further comprising obtaining an image of the cells prior to the addition of an effector compound and obtaining an image of the cells after the addition of an effector compound.

25. The method of claim 1, where two or more cell types are present in the sample.

26. The method of claim 1, wherein one cell type is discriminated from another cell type using a fluorescent tag, fluorescently encoded protein, spatial information, cell morphology, or a combination of these features.
